(19) United States
(12) Patent Application Publication
(10) Pub. No.: US 2009/0242365 A1
(43) Pub. Date: Oct. 1, 2009

(54) SWINGING LEAD SWITCH FOR AN ELECTRONIC DEVICE

(76) Inventor: Jiahn-Chang WU, Hsinchu (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/327,989

(22) Filed: Dec. 4, 2008

(30) Foreign Application Priority Data
Mar. 25, 2008 (TW) 097110540

(51) Int. Cl. H01H 1/12

(52) U.S. Cl. 200/275

(57) ABSTRACT

An electronic device such as a light device or a voice device which has two electrodes; one of the electrodes electrically couples to a freely swinging lead. A first terminal of a power supply couples to a first electrode of the device, a second terminal is configured in a position within a swinging range of the chain lead; the electronic device is turned on/off when the chain lead swings to touch/leave the second electrode. A tilt indicator, vibration indicator, a voice toy or a light emitting toy actuated by vibration or tilt can be made according to the invention.

### RELATED APPLICATIONS

The present application is based on, and claims priority from Taiwan Application Serial Number 097110540, filed Mar. 25, 2008, the entire disclosure of which is incorporated by reference herein.

### TECHNICAL FIELD

This invention relates to a switch mechanism, especially to an electronic device to be turned on/off through a freely swinging lead.

### BACKGROUND

A light emitting diode is taken to be an example as one of many electronic devices; the light source can be replaced with an audio source or a visual-audio device.

### SUMMARY OF THE INVENTION

A first object of this invention is to develop a light emitting diode which is able to turn on/off when it tilts or vibrates.

A second object of this invention is to develop a tilt detector, vibration detector with simpler structure.

A third object of this invention is to develop a toy that gives visual or audio response to title or vibrate.

### BRIEF DESCRIPTION OF THE DRAWINGS

FIG. 1 shows a Prior Art.

FIG. 2 shows a first position of a first embodiment.

FIG. 3 shows a second position of a first embodiment.

FIG. 4 shows a first application with this invention.

FIG. 5 shows a second application with this invention.

### DETAILED DESCRIPTION OF THE PREFERRED EMBODIMENTS

A light emitting diode has two leads, a first lead electrically couples to a first terminal of a power supply. A second lead is made freely swinging to electrically couples to a second terminal of the power supply at some positions. A chain leads is an example of the freely swinging lead. The second terminal of the power supply is configured in a position within a swinging range of the chain lead. The diode is turned on when the chain lead touches the second terminal of the power supply; and the diode shall be turned off when the chain lead leaves the second terminal of the power supply.

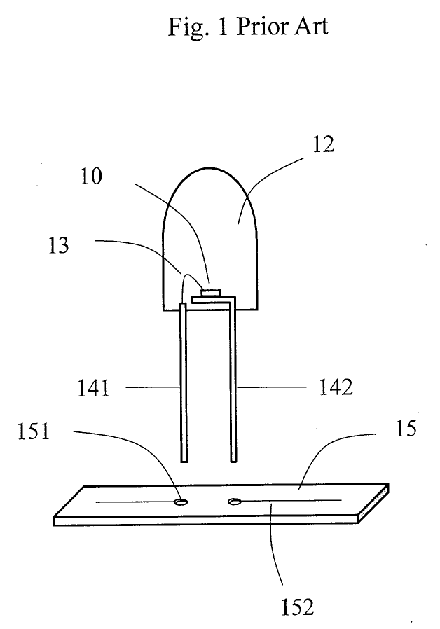

FIG. 1 Shows a Prior Art

FIG. 1 is a traditional light emitting diode (LED) package, which shows a light emitting diode 10 on a top flat portion of a lead 142; the diode 10 has a bottom electrode electrically couples to the lead 142 to which it mounts. A wire 13 electrically couples a top electrode of the diode 10 to a second lead 141. The two leads 141, 142 are traditionally made rigid ones, and combined on top by protection glue 12. A circuit board 15 has corresponding plated through holes (PTH) for an insertion of the two leads 141, 142; solder paste(not shown in the figure) is applied to fix the leads 141,142 between the leads and the through holes 151, the light emitting diode device is thereby fixed onto the circuit board 15. The light emitting diode 10 is turned on/off through controlling of a power supply coupling to it. The traditional device can not be used in some places where device tilt detection or device vibration detection is needed. The prior art light emitted device can not respond to its position when tilts, vibrates, trembles, or turns over.

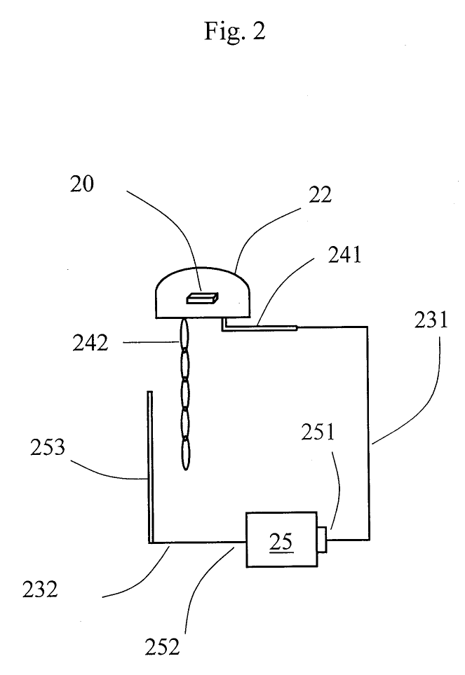

FIG. 2. Shows a First Position of a First Embodiment.

A light emitting diode 20 is embedded in protective glue 22, light emitting diode 20 has two electrodes electrically coupling to a first lead 241 and a second chain lead 242 respectively. A power supply 25 has two terminals, a first terminal 251 electrically couples to the first lead 241, a second terminal 252 has an electrical contact 253 configured in a position within a swinging range of the chain lead 242. FIG. 2 shows that the chain lead 242 hangs down by gravity in a position not contact with the terminal 253, the diode 20 is turned off at this moment.

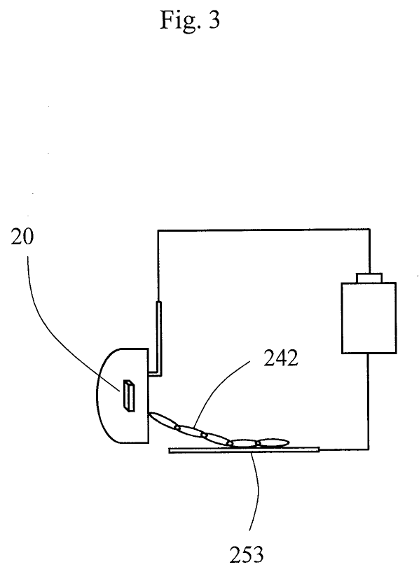

FIG. 3. Shows a Second Position of a First Embodiment.

FIG. 3 shows a position when the diode 20 lying down, the freely swinging lead 242 touches the terminal 253, current passes through the diode 20 at this moment, the diode 20 is turned on.

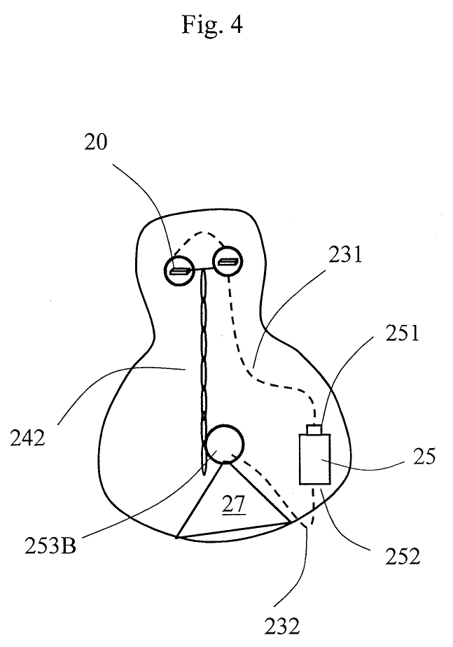

FIG. 4. Shows a First Application with this Invention.

A tumbler has two eyes each equipped with a light emitting diode 20, a chain lead 242 electrically couples to the diodes 20; a power 25 has two terminals 251, 252, the first terminal 251 electrically couples to a first electrode of two diodes 20 through wire 231; the second terminal 252 has an extended power contact 253B, wire 232 is used to couple the power contact 253B and the second terminal 252; the power contact 253B is supported by a rack 27. The power contact 253B is configured in a position within a swinging range of the chain lead 242. FIG. 4 shows the chain lead 242 hangs down by gravity and touches the power contacts 253B so that both of the diodes 20 i.e., the eyes of the tumbler are turned on. The diodes 20 shall be turned off at moments when the chain lead 242 leaves the contact 253B while the tumbler swings or tilts.

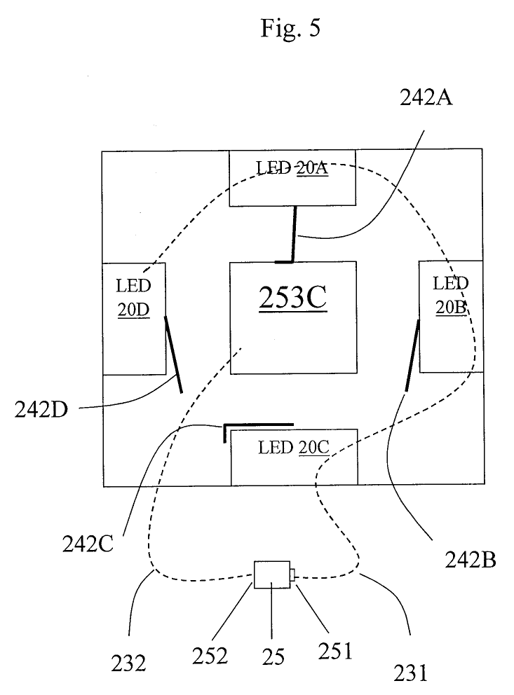

FIG. 5. Shows a Second Application with this Invention.

A section view of a dice embedded with a device according to this invention disclosure is shown in FIG. 5. A dice has six sides, but in section view, four LEDs 20A˜20D are each configured on one of the four sides; each of the LEDs has a chain lead 242A˜242D. A power supply 25 has a first terminal 251 electrically coupling to a first electrode of the four LEDs 20A˜20D through wire 231, a second terminal 252 electrically coupling to a power contact 253C through wire 232. Power contact 253C is configured in a position within a swinging range of each of the chain leads 242A˜242D.

Only the top surface of the dice in FIG. 5 is illuminant with LED 20A turned on while the other surfaces are dark, because only chain lead 242A touches the power contact 253C by gravity, while none of the other chain leads 242B˜242D touches the power contact 253C. Therefore, only LED 20A is charged to illuminate.

The light emitting diode used in this invention can be replaced with a voice device. Additional applications such as a toy can be designed to incorporate this invention to give audio/visual effect in response to tilt or vibration to enhance versatility of a toy. While several embodiments have been described by way of example, it will be apparent to those skilled in the art that various modifications may be made in the embodiments without departing from the spirit of the present invention. Such modifications are all within the scope of the present invention, as defined by the appended claims.

What is claimed is:

1. A swinging lead switch for an electronic device, comprising:
an electronic device, having a first lead and a second lead freely swinging by gravity;
a first terminal of a power electrically coupling to said first lead; and
a second terminal of the power configured in a position within a swinging range of the second lead.

2. A swinging lead switch for an electronic device as claimed in claim 1, wherein said electronic device is a visual device.

3. A swinging lead switch for an electronic device as claimed in claim 1, wherein said electronic device is an audio device.

4. A tumbler, comprising a swinging lead switch as claimed in claim 1.

5. A dice, comprising a swinging lead switch as claimed in claim 1.

6. A vibration detector, comprising a swinging lead switch as claimed in claim 1.

7. A tilt indicator, comprising a swinging lead switch as claimed in claim 1.

8. A toy, comprising a swinging lead switch as claimed in claim 1.
